(19) United States
(12) Patent Application Publication
(10) Pub. No.: US 2009/0094888 A1
(43) Pub. Date: Apr. 16, 2009

(54) Agricultural growth control apparatus and method

(75) Inventor: Timothy A. Bynon, Santa Ana, CA (US)

Correspondence Address: LYNN, John H., 5317 University Drive #517, Irvine, CA, 92612, US

(73) Assignees: Blower-Demsey Corp.; dba PAK WWST Paper and Packaging

(21) Appl. No.: 11/973,904

(22) Filed: Oct. 10, 2007

(51) Int. Cl. A01G 13/02

(52) U.S. Cl. 47/29.7

(57) ABSTRACT

A device for controlling growth patterns of lower limbs of a tree or shrub is formed from a sheet of a flexible material having first and second edges such that deforming the sheet to place the first and second edges in contact produces a hollow, tapered device. The device has a first end opening and a second end opening that is larger than the first end opening. The sheet preferably has a plurality of elongate passages near the first end opening arranged to define a plurality of tapered end portions. A fastening device may be used for connecting portions of the first and second edges together such that the agricultural growth control device may be assembled around a tree trunk adjacent the lower limbs of the tree. A tying device fastened around the tapered end portions secures the agricultural growth control device to the tree.

### BACKGROUND OF THE INVENTION

This invention relates generally to agriculture and particularly to trees for producing agricultural products such as fruit and nuts. Still more particularly, this invention relates to controlling the direction of growth of branches of trees and shrubs.

Uncontrolled growth of trees such as fruit trees can reduce crop yield and make harvesting difficult and time consuming.

### SUMMARY OF THE INVENTION

An agricultural growth control device according to the present invention for controlling growth patterns of lower limbs of a tree or shrub comprising a sheet of a flexible material formed to have first and second edges such that deforming the sheet to place the first and second edges in contact produces a hollow tapered device. The agricultural growth control device has a first end opening and a second end opening that is larger than the first end opening. The sheet preferably has a plurality of elongate passages near the first end opening arranged to define a plurality of tapered end portions. A fastening device may be used for connecting portions of the first and second edges together such that the agricultural growth control device may be assembled around a tree trunk adjacent the lower limbs of the tree.

The agricultural growth control device preferably further comprises a stake secured in the ground adjacent the tree and a tying device fastened around the tapered end portions and the stake so that the agricultural growth control device is securely connected to the tree.

The agricultural growth control device according to the present invention preferably is formed such that the sheet has a plurality of fold lines arranged such that folding the sheet along the fold lines forms the agricultural growth control device to have a generally truncated pyramid configuration.

The fastening device may comprise a slot formed in the sheet and a locking tab arranged for locking within the slot to retain the sheet in a configuration selected for the agricultural growth control device.

A method according to the present invention for controlling growth patterns of lower limbs of a tree or shrub comprises the steps of forming a sheet of a flexible material to have first and second edges and deforming the sheet to place the first and second edges in contact, thereby producing a hollow tapered device having a first end opening and a second end opening that is larger than the first end opening. The method may further include the steps of forming a plurality of elongate passages in the sheet near the first end, arranging the elongate passages to define a plurality of tapered end portions, and connecting portions of the first and second edges together such that the agricultural growth control device may be assembled around a tree trunk adjacent the lower limbs of the tree.

### BRIEF DESCRIPTION OF THE DRAWINGS

FIG. 1 shows an agricultural growth control device according to the present invention attached to a tree;

FIG. 2 is a top plan view of a sheet of foldable material that may be used to form the tree training device of FIG. 1;

FIG. 3 is a perspective view of a the invention;

FIG. 4 is a front elevation view of the invention;

FIG. 5 is a rear elevation view of the invention;

FIG. 6 is a right side elevation view of the invention; and

FIG. 7 is a left side elevation view of the invention.

### DETAILED DESCRIPTION OF THE INVENTION

Referring to FIGS. 1 and 3, an agricultural growth control device 10 according to the present invention is shown mounted on a tree 12. The agricultural growth control device 10 preferably is formed basically as a hollow, truncated pyramid having tapered, essentially trapezoidal side panels 14-17. The agricultural growth control device has a first end 20 having a first opening 22 and a second end 24 having a second opening 26 that is larger than the first opening 22.

The agricultural growth control device 10 is mounted to the tree 12 with the first end 20 being fastened around a portion 28 of the tree trunk 30. The agricultural growth control device 10 preferably is mounted to the tree trunk 30 at a height such that the second end 24 contacts the lower branches 32 of the tree 12. The agricultural growth control device 10 normally is secured into a selected position with a tying device 33 that is wrapped around the tree trunk 30 and a stake 34. The agricultural growth control device 10 is formed to have structural integrity such that the lower portions of the tree 12 grow upward and generally outward from the edges of the second end 24.

The agricultural growth control device may be used to train the growth pattern of the tree 12 (or a shrub). Making the limbs of a fruit tree, for example, grow upward and out from the tree trunk instead downward increases crop yield and facilitates harvesting by keeping fruit from being on or near the ground. Bunching of branches, limbs or stems may be controlled. The agricultural growth control device 10 promotes growth while providing protection from insecticide spray. The agricultural growth control device 10 also centralizes concentration of fertilizer applied by spraying or dusting.

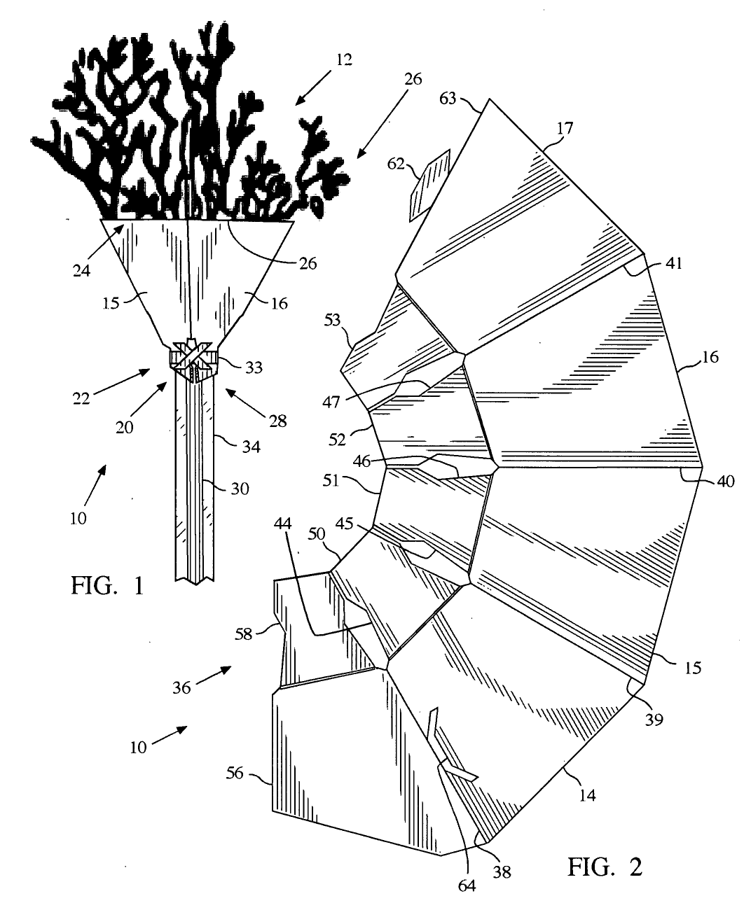

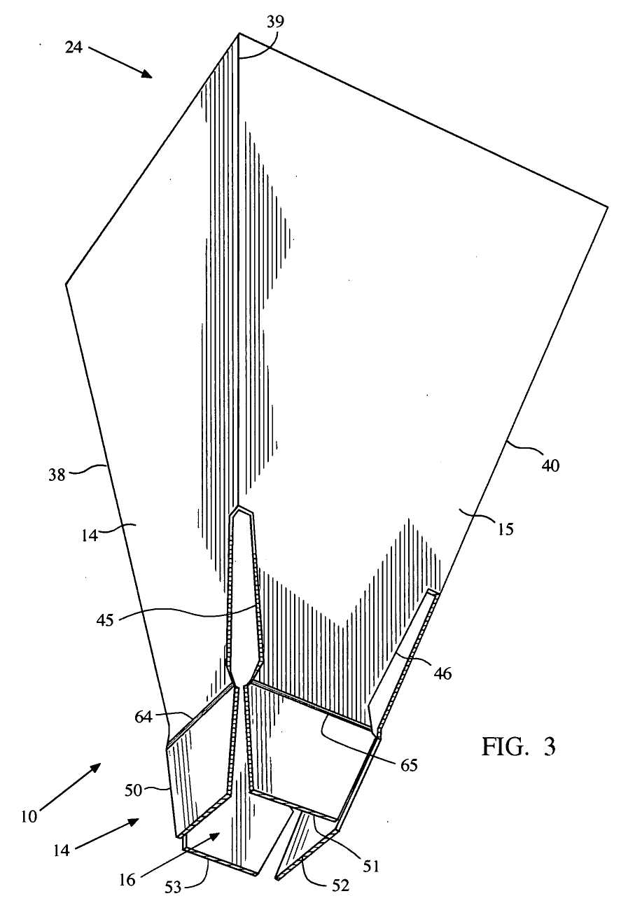

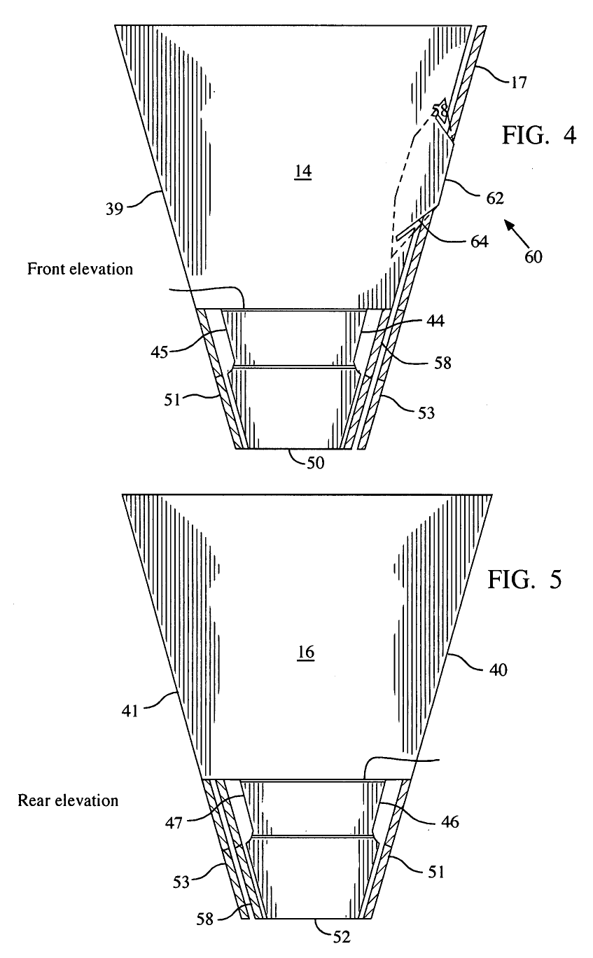

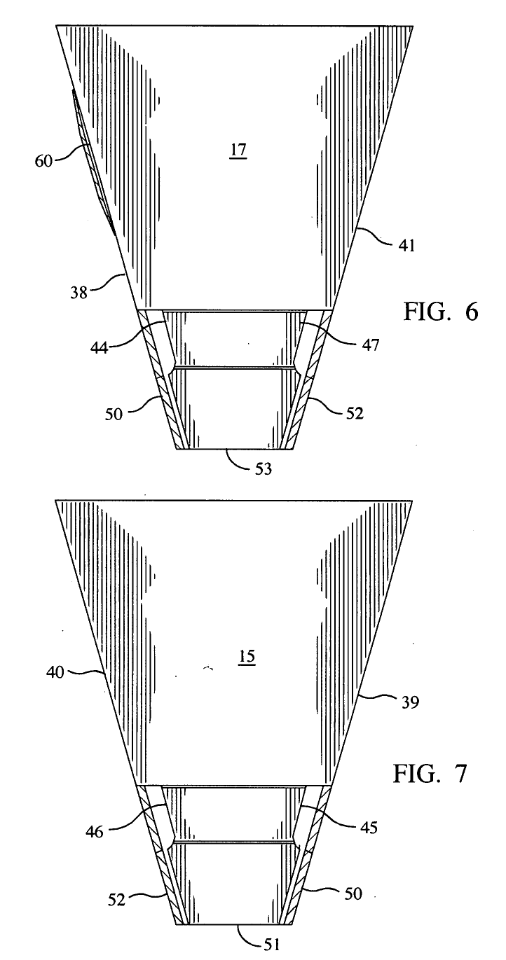

Referring to FIG. 2, the agricultural growth control device 10 preferably is formed from a flat sheet 36 that is formed of any suitable material such a paper, waxed paper, solid fiber, liner board, corrugated paper or plastic. The sheet 36 is cut by any suitable method such as die cutting to form the components of the agricultural growth control device 10. Referring to FIGS. 2-7, the sheet 36 preferably is formed to be folded along lines 38-41 to define the side panels 14-17 of the agricultural growth control device 10. A plurality of elongate passages 44-47 are formed in the sheet 36 in alignment with the fold lines 38-41. The passages 44-47 define a plurality of tapered end portions 50-53 that extend from the smaller ends of the side panels.

The agricultural growth control device 10 is normally packaged and shipped in flat sheet form. Attaching the agricultural growth control device 10 to the tree 12 normally includes the steps of driving the stake 34 into the ground near the tree trunk 30, placing the sheet 36 adjacent the selected portion of the tree 12, folding the sheet 36 along the fold lines 38-41, inserting the locking tab 62 into the slot 64 and securing the agricultural growth control device 10 to the tree with the tying device 33.

FIG. 2 also shows a tapered panel 56 having a tapered end portion 58 formed adjacent the side panel 14 and tapered end portion 50. When the agricultural growth control device is assembled as shown in FIGS. 1 and 3-7, the side panel 17 covers the panel 56. Referring to FIGS. 2, 4 and 6, a fastening device 60 connects the side panel 17 to the side panel 14. The fastening device 60 may be formed to include a locking tab 62 extends from an edge 63 of the side panel 17 into a slot 64 formed in the side panel 60 adjacent the fold line 38.

The structures and methods disclosed herein illustrate the principles of the present invention. The invention may be embodied in other specific forms without departing from its spirit or essential characteristics. The described embodiments are to be considered in all respects as exemplary and illustrative rather than restrictive. Therefore, the appended claims rather than the foregoing description define the scope of the invention. All modifications to the embodiments described herein that come within the meaning and range of equivalence of the claims are embraced within the scope of the invention.

Instead of being formed generally as a truncated pyramid, the agricultural growth control device 10 may be formed so that it has a generally frustoconical shape when assembled with the locking tab being inserted into the slot 62. The fastening device may alternatively be an adhesive, tape, staple, heat seal, folding or other suitable method for sealing or locking the edges of the sheet 36 together to form the agricultural growth control device 10 to have the end openings 20 and 26 as described previously.

What is claimed is:

1. An agricultural growth control device for controlling growth patterns of lower limbs of a tree or shrub, comprising: a sheet of a flexible material formed to have first and second edges such that deforming the sheet to place the first and second edges in contact produces a hollow tapered device having a first end opening and a second end opening that is larger than the first end opening, the sheet having a plurality of elongate passages near the first end opening arranged to define a plurality of tapered end portions, and a fastening device for connecting portions of the first and second edges together such that the agricultural growth control device may be assembled around a tree trunk adjacent the lower limbs of the tree.

2. The agricultural growth control device of claim 1, further comprising a stake secured in the ground adjacent the tree and a tying device fastened around the tapered end portions so that the agricultural growth control device is securely connected to the tree.

3. The agricultural growth control device of claim 1 is formed such that the sheet has a plurality of fold lines arranged such that folding the sheet along the fold lines forms the agricultural growth control device to have a generally truncated pyramid configuration.

4. The agricultural growth control device of claim 3 wherein the fastening device comprises a slot formed in the sheet and a locking tab arranged for locking within the slot to retain the sheet in a configuration selected for the agricultural growth control device.

5. The agricultural growth control device of claim 1 wherein the fastening device comprises a slot formed in the sheet and a locking tab arranged for locking within the slot to retain the sheet in a configuration selected for the agricultural growth control device.

6. A method for controlling growth patterns of lower limbs of a tree or shrub, comprising the steps of: forming a sheet of a flexible material to have first and second edges, deforming the sheet to place the first and second edges in contact, thereby producing a hollow tapered device having a first end opening and a second end opening that is larger than the first end opening, forming a plurality of elongate passages in the sheet near the first end, arranging the elongate passages to define a plurality of tapered end portions, and connecting portions of the first and second edges together such that the agricultural growth control device may be assembled around a tree trunk adjacent the lower limbs of the tree.

7. The method of claim 6, further comprising the step of securing a stake in the ground adjacent the tree and a tying device fastened around the tapered end portions so that the agricultural growth control device is securely connected to the tree.

8. The method of claim 6, further comprising the steps of forming a plurality of fold lines in the sheet, and arranging the plurality of fold lines such that folding the sheet along the fold lines forms the agricultural growth control device to have a generally truncated pyramid configuration.

9. The method of claim 8 further comprising the steps of forming a slot in the sheet and arranging a locking tab to be locking within the slot to retain the sheet in a configuration selected for the agricultural growth control device.

10. The method of claim 6 further-comprising the steps of forming a slot in the sheet and arranging a locking tab to be locking within the slot to retain the sheet in a configuration selected for the agricultural growth control device.
